(19) United States
(12) Patent Application Publication
(10) Pub. No.: US 2016/0073094 A1
(43) Pub. Date: Mar. 10, 2016

(54) DEPTH MAP ENHANCEMENT

(71) Applicant: Microsoft Corporation, Redmond, WA (US)

(72) Inventors: Sing Bing KANG, Redmond, WA (US); Adam KIRK, Seattle, WA (US); Avanish KUSHAL, Seattle, WA (US)

(73) Assignee: MICROSOFT CORPORATION, Redmond, WA (US)

(21) Appl. No.: 14/479,150

(22) Filed: Sep. 5, 2014

(51) Int. Cl. H04N 13/02; G06T 7/00

(52) U.S. Cl. CPC H04N 13/0271; H04N 13/0257; H04N 13/0296; G06T 7/0071; H04N 13/0221; G06T 2207/10012; G06T 2207/10028

(57) ABSTRACT

The description relates to depth images and obtaining higher resolution depth images through depth dependent measurement modeling. One example can receive a set of depth images of a scene captured by a depth camera. The example can obtain a depth dependent pixel averaging function for the depth camera. The example can also generate a high resolution depth image of the scene from the set of depth images utilizing the depth dependent pixel averaging function.

### BACKGROUND

Depth sensors are becoming readily available in many types of computing devices. Many depth sensors have limited image resolution. The inventive concepts can increase the effective resolution of a depth map captured by these depth sensors.

### SUMMARY

The description relates to depth images (e.g., depth maps) and obtaining higher resolution depth images through depth dependent measurement modeling. One example can receive a set of depth images of a scene captured by a depth camera. The example can obtain a depth dependent pixel averaging function for the depth camera. The example can also generate a high resolution depth image of the scene from the set of depth images utilizing the depth dependent pixel averaging function.

The above listed example is intended to provide a quick reference to aid the reader and is not intended to define the scope of the concepts described herein.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIGS. 1, 2, and 10 show depth image resolution enhancement systems in accordance with some implementations of the present concepts.

FIGS. 3-5 show graphical representations of some example results in accordance with some implementations.

FIGS. 6-9 show low resolution depth images and corresponding high resolution depth images to which the present depth image resolution enhancement concepts can be applied in accordance with some implementations.

FIGS. 11-12 are flowcharts of depth map image enhancement techniques in accordance with some implementations of the present concepts.

### DETAILED DESCRIPTION

### Overview

The description relates to enhancing depth image (e.g., depth map) resolution. An individual depth sensor has a capability to capture depth maps of a given resolution. The present implementations can enhance that given resolution. For instance, the present implementations can produce an enhanced depth map that has two times or three times (or more) the resolution as the given resolution. For example, some of the present implementations can increase the effective resolution (e.g., super-resolution) of the captured depth map using slightly shifted versions of a given scene. Toward this end, these implementations can address both pixel averaging functions and noise functions over distance in super-resolving the captured depth map.

Viewed from another perspective, some of the inventive concepts can create a higher-resolution depth map from several shifted versions of depth maps of the same scene. Implementations employing these inventive aspects can iterate between two stages. Namely, these implementations can estimate a higher-resolution depth map using the input depth maps and current weights. These implementations can then update the weights based on the current estimate of the higher-resolution depth map, depth dependent noise characteristics, and/or depth dependent pixel averaging function.

### Scenario Examples

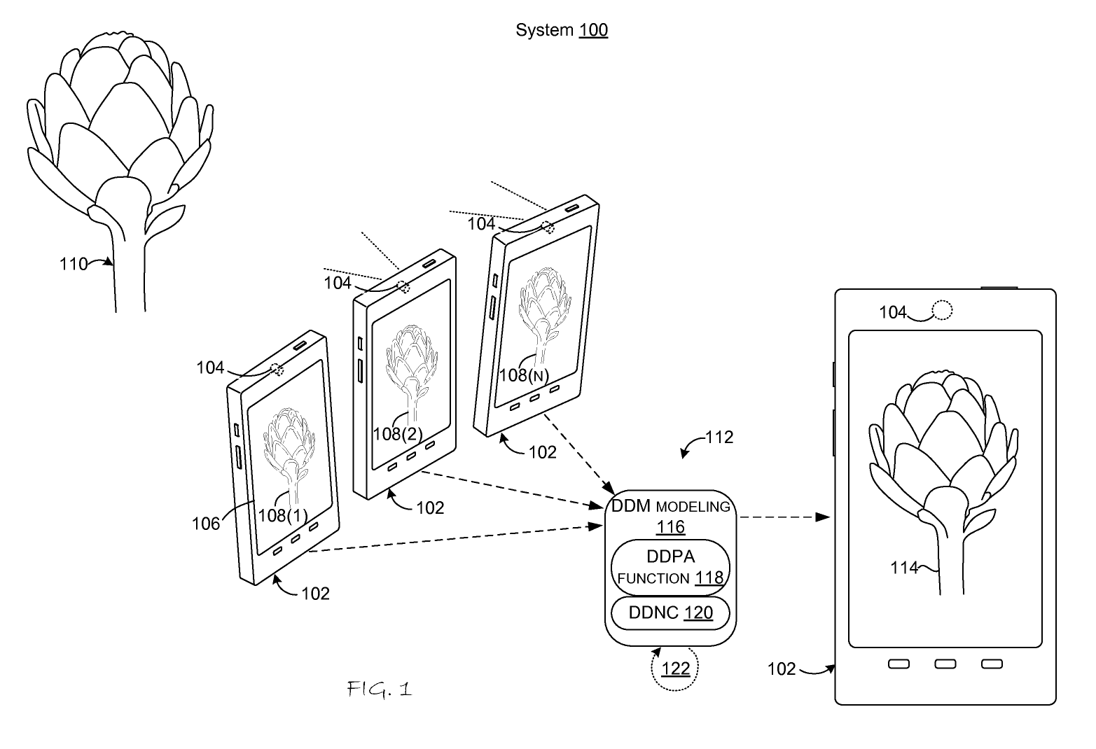

FIG. 1 shows an example system 100 that includes a device 102. For purposes of explanation, device 102 appears multiple times in FIG. 1. In this case, the device is manifest as a smart phone that includes a depth camera 104 (shown in ghost since it is facing away from the reader). For instance, the depth camera may be a stand-alone component or the depth camera may be part of a red, green, blue+depth camera. This particular device 102 can also include a display 106.

The device 102 can capture a set of depth images (L) (e.g., depth maps) 108 of a subject 110. In this case, the subject is an artichoke, though of course the device can capture images of any subject. The captured depth images 108 can be referred to as low resolution depth images that can be collectively processed at 112 to create a high resolution image or latent image 114 of the subject 110. (Note that in subsequent discussions the high resolution image may be referred to as “H” and the low resolution images may be referred to as “L”). In this implementation, the processing 112 can entail depth dependent measurement modeling (or DDM modeling) 116. In some implementations, the DDM modeling can consider a depth dependent pixel averaging (DDPA) function 118 and/or depth dependent noise characteristics (DDNC) 120. In some cases, the processing 112 can be performed in an iterative manner as indicated at 122 to obtain the high resolution image 114 from the set of depth images 108. These aspects are described in more detail below.

Stated another way, one technical problem that is addressed by the present implementations is the ability to generate a high resolution (e.g., super-resolution) depth image from a set of available low resolution images. Existing color image super-resolution techniques provide sub-par solutions when applied to depth images. The technical solution can utilize depth dependent pixel averaging functions to generate super-resolution depth images of higher resolution than can be obtained with existing techniques. Thus, regardless of the resolution of the depth camera, the present techniques can provide a higher resolution depth image. This higher resolution depth image can provide depth details to a user who might otherwise be unsatisfied with the results provided by the depth camera via existing techniques.

### Depth Dependent Pixel Averaging Functions

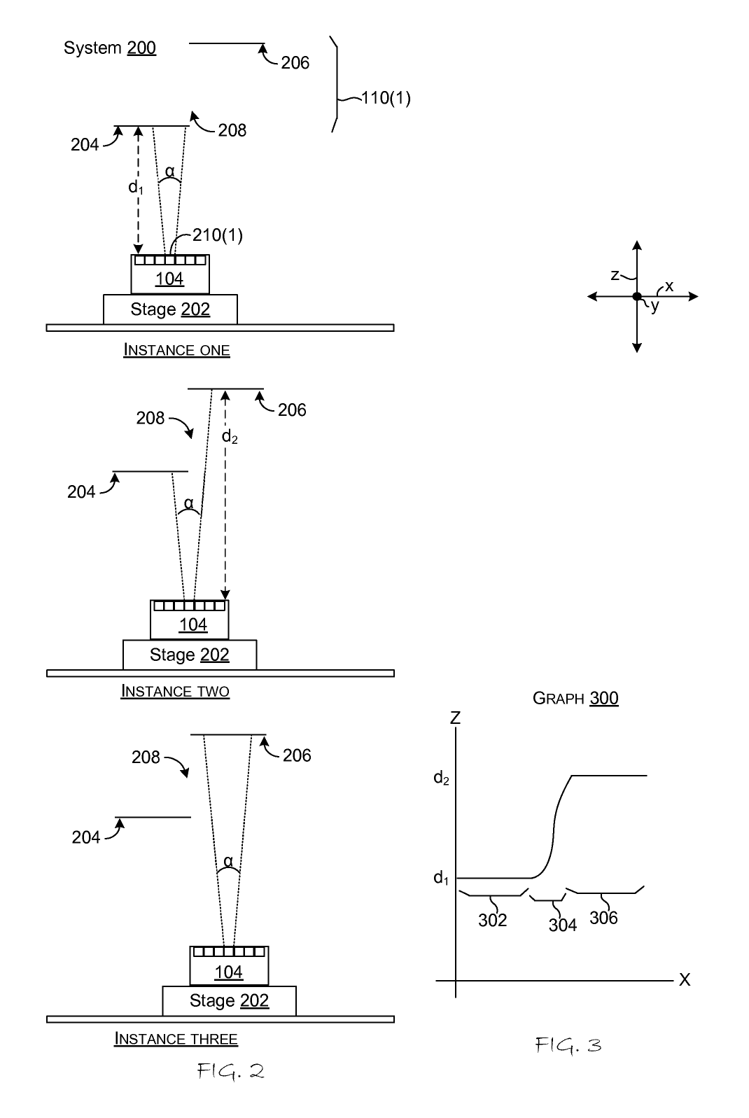

FIG. 2 shows an example system 200 for identifying depth dependent pixel averaging functions for depth camera 104. FIG. 3 shows depth results from system 200. The system of FIG. 2 is being utilized to identify the depth dependent pixel averaging function of depth camera 104 and the results are shown in FIG. 3. For purposes of explanation, depth dependent pixel averaging functions are being identified for individual depth camera 104. Note that in many circumstances, the depth dependent pixel averaging functions can be identified for a model of the depth camera. For instance, the identifying could be performed by a manufacturer. The identified depth dependent pixel averaging functions could then be applied to the individual depth cameras of that model.

In system 200, depth camera 104 is positioned on a stage 202. The system includes scene or subject 110(1). A first portion 204 of the scene is at a first depth d₁ in the z reference direction and a second portion 206 of the scene is at depth d₂. The scene also includes a depth discontinuity 208 between the first portion 204 and the second portion 206. Depth camera 104 can include an image sensor, such as a charge coupled device (CCD) that can capture pixels 210 of information. In this case for ease of explanation only one pixel 210(1) is labeled and discussed with particularity. Individual pixels can include information from the scene within a region α. For simplicity of illustration, system 200 is discussed in two dimensions (x and z) but includes the third (y) dimension. The aspects discussed here relative to the x reference axis or dimension can also be applied to the y reference axis.

The stage 202 can be precisely moved in the x reference direction. For instance, the stage can be moved in sub-pixel increments along the x reference axis. For sake of brevity, three instances are shown in FIG. 2, but in practice, depth images can be obtained at hundreds or thousands of incremental positions along the x reference axis.

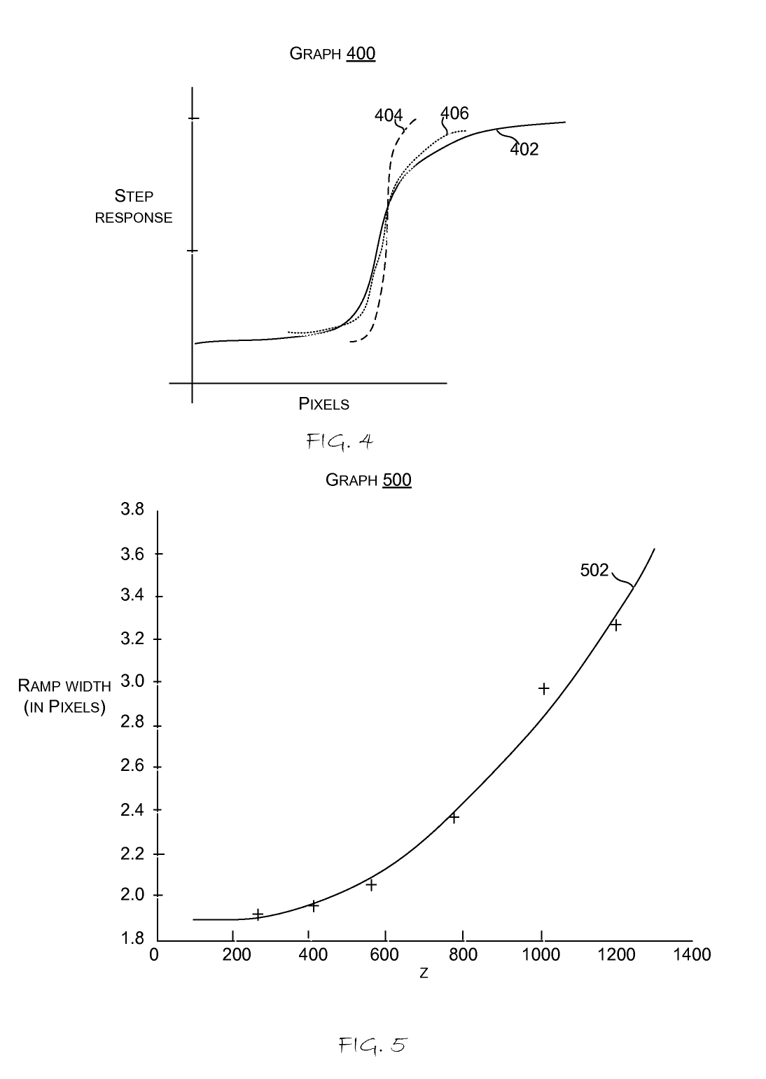

The discussion now collectively refers to FIGS. 2-3. At Instance One of FIG. 2, region α exclusively covers first portion 204. As such, the recorded z direction depth on graph 300 is depth d₁ as indicated at 302. The recorded depth continues to be d₁ approximately until region α includes both the first portion 204 and the second portion 206 as shown at Instance Two (e.g., region α includes discontinuity 208). This is reflected on graph 300 at 304. At Instance Three, further movement in the positive x direction causes region α to exclusively cover portion 206 as reflected at 306 on graph 300. From one perspective, graph portion 304 can be thought of as representing a step response function of individual pixel 210(1). An individual step response function can be noisy and thus it can be difficult to measure either the shape or the spread of the step response function. To remedy this, many captures can be taken and the average profile computed. Alternatively, if the boundary of the discontinuity 208 is exactly along the y-direction of the image, rows across the edge in the same image can be averaged to reduce noise. The width of the response function will depend on the depth of the boundary. For instance, graph 400 in FIG. 4 shows step response functions for three different depths: a solid line 402 representing one step response function associated with a first depth, a dashed line 404 representing another step response function associated with a second depth, and a dotted line 406 representing a third step response function associated with a third depth.

FIG. 5 shows a graph 500 that illustrates an example of one mean profile 502. The mean profile 502 can be attained by fitting step functions to all the profiles and shifting the step functions by an amount so that all of step functions are aligned with respect to the step discontinuity. The mean profile for all the pixels can be computed from the aligned step functions. Referring back to FIGS. 2-3 collectively with FIG. 5, the mean profile 502 can indicate graphically the shape of the depth dependent pixel averaging function of depth camera 104. Contrary to other image enhancement techniques, such as those used for color images, the depth dependent pixel averaging function is not simply the average of the adjacent values at d₁ and d₂. Further, the width of the depth dependent pixel averaging function at 304 is not necessarily the same as the width of region α at the discontinuity 208. Instead, the width of the ramp function can be dependent on the depth and can increase monotonically with depth. This can motivate the use of a variable sized kernel at different regions of the image. As mentioned above, FIG. 5 shows the variation of the width of a well-fitting (and potentially best fitting) ramp function versus distance from the sensor (e.g., depth camera). In this case the width varies from about 1.8 pixels to about 3.2 pixels across the depth range from 200 millimeters (mm) to 1200 mm. Thus the discontinuities can be expected to be very sharp for small distances in the z direction, but extremely blurred at larger distances in the z direction. Of course, the shape of the depth dependent error at 304 is only one possible shape, and depth dependent pixel averaging functions for other depth cameras can have other shapes.

### Depth Dependent Noise Characteristics

The depth measurements from depth cameras, such as depth camera 104 of FIG. 1, can be corrupted by numerous error sources. Fundamentally, the strength of sensor noise is dependent on the depth.

While the strength of the noise is dependent on the depth, the mean of many samples is expected to be very close to the correct depth value. Toward this end, some implementations can take multiple observations (such as 500 to 1000 or more) of a plane. A mean of the observations can then be determined. A second plane can then be fit to the mean. The second plane can be treated as a ground truth and deviations from this plane can be analyzed as noise distributions. Some implementations can fit a 2D spline to characterize the spatial error distribution within the second plane. The spline can then be extended to 3D to correct similar errors at different depths.

Further, individual sensors of the depth camera may not always give the same depth readings for a given scene (e.g., depth readings can vary with environmental conditions). For instance, a plot of the mean depth of a captured frame (over all the pixels) vs time can illustrate that the mean depth may not be constant even for a static scene, but rather may fluctuate in regular patterns. This fluctuation can be a function of the internal temperature of the depth camera and/or the external temperature of the room. To overcome this, some implementations can capture a relatively large number of frames, such as 500-1000, at each location (once the depth camera has settled down into the regular pattern) and then take a set of contiguous frames, such as 100, that are as close as possible to each other in their mean depth. Information obtained under different conditions can be stored, such as in a look up table. The information can be accessed when the depth camera subsequently captures depth images under similar conditions. Stated another way, the depth camera can be pre-calibrated to the closest set of stored conditions and interpolation can be used to fine tune the calibration.

The difference between the frames can be modeled as an additive noise; though using an affine model is also possible. As such, individual frames can be adjusted to have the same mean intensity.

### Random Noise

Some implementations can measure the random noise characteristics of the depth camera 104 by placing a plane in a fronto parallel position in front of the depth camera. A number of frames, such as 500-1000, can be captured. The mean frame can be computed by averaging these 500-1000 frames at each location of the depth map. A second plane can be fit to this mean frame and treated as a ground truth depth. Errors between the ground truth and the depths can be measured and returned in every frame at each location to build a histogram of errors. This process can be repeated at multiple depths. The error distributions tend to be approximately Gaussian. Also, errors tend to be much larger at larger depths (the distributions have larger variance). A variation can be calculated of the sigma of the fitted Gaussian (σ) to these distributions versus depth. Sigma tends to have a linear dependence on the depth of the scene (Z).

### Algorithm Examples

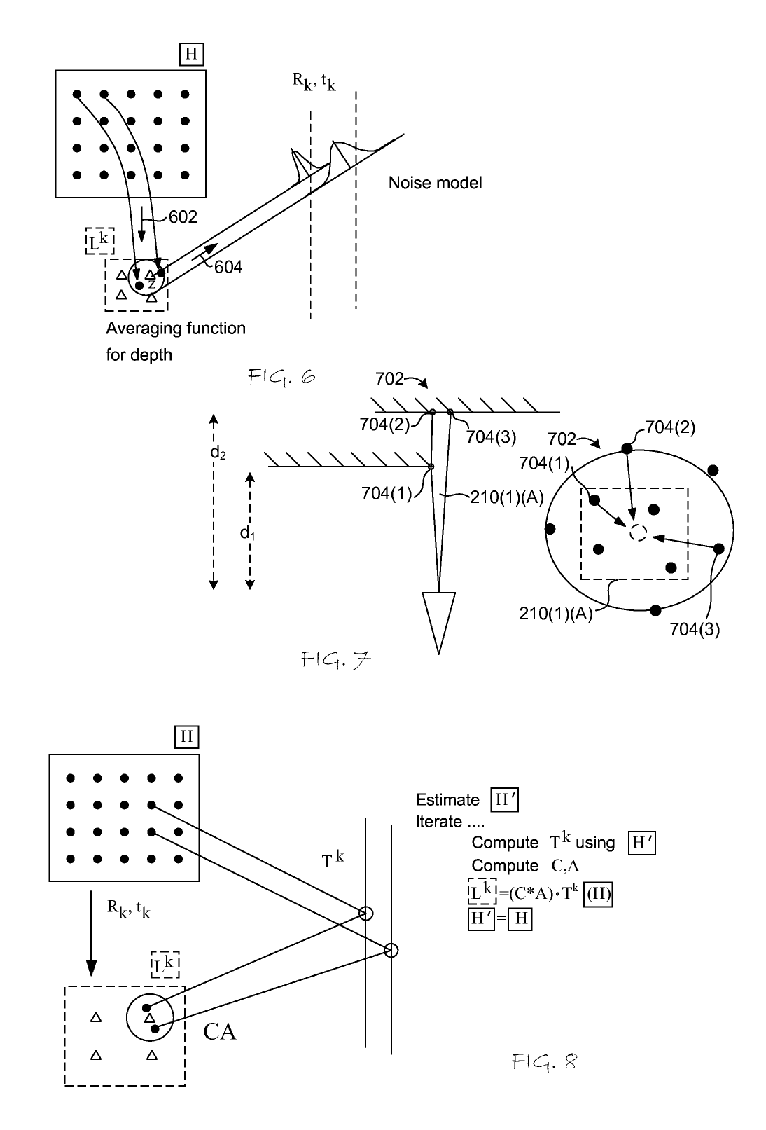

FIGS. 6-8 collectively illustrate, at a high level, example algorithms that can be utilized with the present concepts. Some of this content was introduced in various sections of the discussion above. FIGS. 6-8 serve to explain an end-to-end scenario. Specific content discussed relative to FIGS. 6-8 is described in greater detail following the discussion.

For purposes of explanation assume that an initial estimate of the higher-resolution (e.g., super-resolved) image is available and is designated as output H in FIG. 6. Assume also that there is a transform T^{k} (consisting of rotation Rₖ and translation tₖ) between H and any of the low resolution images (e.g., depth map input L^{k}). The present implementations can then project points from H to each of the L^{k}s as shown at 602. The depth at each pixel in L^{k} has some uncertainty; this uncertainty is in the form of the depth dependent error function previously measured (shown above as Gaussian distributions). In addition, from the estimated depth dependent error function, the local values of H can be combined to (potentially) optimally explain the observations in the form of L^{k}s as indicated at 604 (given rotation Rₖ and translation tₖ between the high resolution image H and the low resolution image L^{k}). Thus, noise characteristics can be plotted at different depths. As mentioned, the plots can be computed based on deviation from the plane at each distance from the depth sensor. At each distance, the plane equation can be estimated from many (e.g., hundreds) of samples.

FIG. 7 is similar to FIG. 2 and illustrates an example of the depth dependent pixel averaging function for one pixel 210(1)(A) illustrated as a footprint 702. This footprint straddles two depths: d₁ and d₂. The depth dependent pixel averaging function determines what the measured value is given samples from both depths. In this implementation the depth dependent pixel averaging function is a function of the percentage of coverage of the pixel in each area at a different depth. Stated another way, the depth dependent pixel averaging function can determine the depth of the low resolution image L^{k} from the depths 704(1), 704(2), and 704(3) represented in the high resolution image H.

FIG. 8 can combine the concepts introduced above in FIGS. 6-7. This particular algorithm has two stages. First, an estimate H′ of the super-resolved image H can be computed. H′ can be set to H, and the geometric transform T^{k} between itself and the input depth maps L^{k} can be computed. An area matrix A can be computed based on how much of a pixel in H falls under a pixel in L^{k}. Initially a weight matrix C can be set to a unit matrix. Second, given H′, the error distributions, and the depth dependent pixel averaging function, the geometric transform T^{k}, area matrix A, and weight matrix C can be updated, leading to a new estimate of H′=H. The first and second stages can be iterated until convergence or a pre-specified iteration number is reached.

This section provides additional detail for computing the high resolution depth image H from a collection of displaced low resolution depth images L^{k} captured from a depth sensor, incorporating both the depth dependent pixel averaging function as well as the depth dependent noise characteristics.

### Using the Depth Dependent Pixel Averaging Function

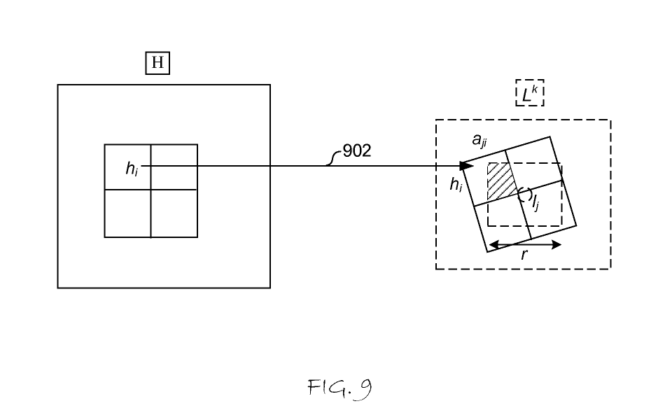

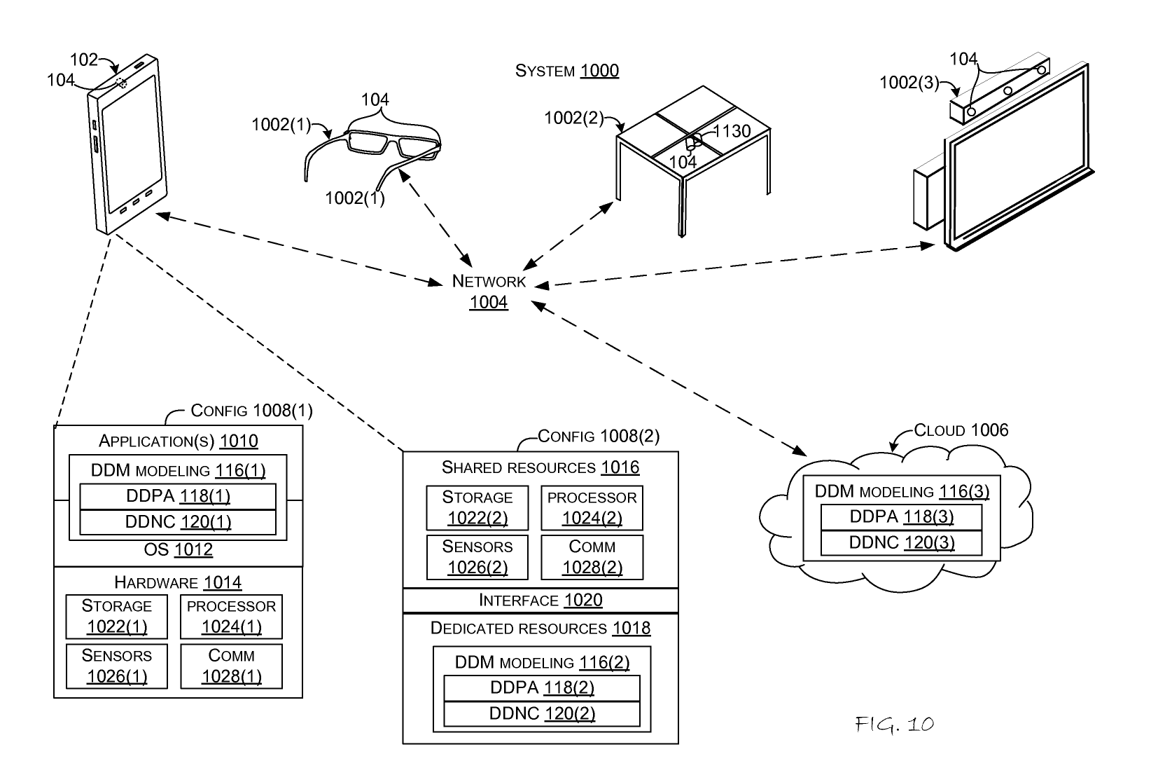

As discussed previously, projecting the high resolution image H onto the low resolution image L^{k} can entail knowing the high resolution image itself. For purposes of explanation, start with the assumption that an estimate of the high resolution image H is available. The high resolution image H can be projected onto each of the low resolution images, in particular on to L^{k}. Let lⱼ be one such low resolution point as shown in FIG. 9, and let r denote the width of the ramp function computed using the depth dependent model for the depth dependent pixel averaging function of the sensor (e.g., depth camera). Let nⱼ be the number of projecting high resolution pixels intersecting the averaging area for the low resolution point lⱼ (e.g., captured by a single pixel). Let hᵢ be one such pixel that intersects the averaging width in the area given by aⱼᵢ (shaded area in FIG. 9). The impulse response function can be a box function, i.e. the contribution of every high resolution pixel hᵢ to lⱼ is determined by aⱼᵢ, and thus all samples can be weighted equally in the following equation:

$${l}_{j} = {\sum }_{i = 1}^{{n}_{j}} {a}_{ji} * {h}_{i} \qquad ( 2 )$$

### Using the Depth Dependent Noise

The discussion above indicates that the depth dependent noise can be characterized using a Gaussian function—thus all samples may not be treated equally. Rather, depending on how far a low resolution sample lⱼ is from the high resolution sample hᵢ, a confidence measure can be defined as:

$${c}_{ji} = {e}^{\frac{- {( {l}_{j} - {h}_{i} )}^{2}}{{σ}_{{h}_{i}}^{2}}} \qquad ( 3 )$$

This confidence measure can be integrated into the formulation so that the formation equation looks like

$${l}_{j} = {\sum }_{i = 1}^{{n}_{j}} {c}_{ji} \cdot {a}_{ji} \cdot {h}_{i} \qquad ( 4 )$$

Combining the constraints from each low resolution sample, the equation can be written succinctly as:

L^{k}=(C^{k}*A^{k})·H, (5)

where * denotes element wise multiplication of matrices,
and C^{k}={cⱼᵢ},A^{k}={aⱼᵢ}

### Iterative Algorithm

Note, that both the areas of intersection and aⱼᵢ cⱼᵢ depend on the value of hᵢ; cⱼᵢ by its definition, and aⱼᵢ, as the value of hᵢ dictates where this sample will project to in each of the images. Solving for aⱼᵢ, cⱼᵢ and hᵢ, together in a joint optimization makes the problem intractable. Thus, some implementations can solve the problem using an iterative algorithm shown in Algorithm 1 shown below:

Algorithm 1 [H] = DepthSuperResolve(L^{k})

```
Warp each LR image L^{k} onto the H
  Compute αⱼᵢ∀i, j, and form the matrix A^{k}
Initialize H ← min_{H} Σₖ || L^{k} − A^{k} * H||₂
Iterate...
  Warp H into each L^{k}
    Compute αⱼᵢ∀i, j, to form the matrix A^{k}
    Compute cⱼᵢ∀i, j, to form the matrix C^{k}
  H ← min_{H} Σₖ || L^{k} − (C^{k} * A^{k}) · H||₂
```

In each iteration of the algorithm, the high resolution image is projected into each of the low resolution images L^{k}, and the areas of intersection aⱼᵢ and confidence measure based on the noise model cⱼᵢ are computed to form the matrices A^{k} and C^{k} respectively. The high resolution image H can be updated by computing the (potentially) best H that explains all the L^{k} in a least squares sense.

Some implementations can initialize the high resolution image H by projecting the low resolution images L^{k} onto the high resolution grid as indicated at 902 and follow the same intersection procedure to compute aⱼᵢ. Stated another way, the area of intersection of the high resolution pixel h, can be computed with the region around lⱼ as given by the ramp width r. These implementations can set cⱼᵢ=1∀i,j, and solve the system of equations for H. This value of H can then be used to initialize an Expectation-Maximization (EM) algorithm.

### System Example

FIG. 10 illustrates an example system 1000 that shows various device implementations of the depth map enhancement concepts. In this case, three device implementations are illustrated. Device 102 is carried over from FIG. 1. Additional devices 1002(1), 1002(2), and 1002(3) are introduced relative to FIG. 10. Device 102 is manifest as a smart-phone type device. Device 1002(1) is manifest as a wearable smart device; in this case smart eyeglasses. Device 1002(2) is manifest as a 3-D printer. Device 1002(3) is manifest as an entertainment console. Of course not all device implementations can be illustrated and other device implementations should be apparent to the skilled artisan from the description above and below. The devices 102, 1002(1), 1002(2), and/or 1002(3) can be coupled via a network 1004. The network may also connect to other resources, such as resources located in the Cloud 1006.

Individual devices 102, 1002(1), 1002(2), and/or 1002(3) can include one or more depth cameras 104. Various types of depth cameras can be employed. For instance, structured light, time of flight, and/or stereo depth cameras can be employed.

Individual devices 102, 1002(1), 1002(2), and/or 1002(3) can be manifest as one of two illustrated configurations 1008(1) and 1008(2), among others. Briefly, configuration 1008(1) represents an operating system centric configuration and configuration 1008(2) represents a system on a chip configuration. Configuration 1008(1) is organized into one or more applications 1010, operating system 1012, and hardware 1014. Configuration 1008(2) is organized into shared resources 1016, dedicated resources 1018, and an interface 1020 there between.

In either configuration, the devices 102, 1002(1), 1002(2), and/or 1002(3) can include storage 1022, a processor 1024, sensors 1026, and/or a communication component 1028. Individual devices can alternatively or additionally include other elements, such as input/output devices, buses, graphics cards (e.g., graphics processing units (CPUs)), etc., which are not illustrated or discussed here for sake of brevity.

Multiple types of sensors 1026 can be included in/on individual devices 102, 1002(1), 1002(2), and/or 1002(3). The depth camera 104 can be thought of as a sensor. Examples of additional sensors can include visible light cameras, such as red green blue (RGB) cameras (e.g., color cameras), and/or combination RGB plus depth cameras (RGBD cameras). Examples of other sensors can include accelerometers, gyroscopes, magnetometers, and/or microphones, among others.

The communication component 1028 can allow individual devices 102, 1002(1), 1002(2), and/or 1002(3) to communicate with one another and/or with cloud based resources. The communication component can include a receiver and a transmitter and/or other radio frequency circuitry for communicating with various technologies, such as cellular, Wi-Fi (IEEE 802.xx), Bluetooth, etc.

Note that in some cases the depth dependent measurement modeling component 116 on an individual device can be robust and allow the individual device to operate in a generally self-contained manner. For instance, as described relative to FIG. 1, device 102 can take a set of low resolution depth images 108 of the subject 110. The depth dependent measurement modeling component 116 can utilize the depth dependent pixel averaging function 118 and the depth dependent noise correction 120 on the set of low resolution depth images. The depth dependent measurement modeling component 116 can then generate the high resolution image 114. The device 102 could then use the high resolution image 114 in various ways. One use could be to send the high resolution image to 3-D printing device 1002(2). The 3-D printer device could then print a replica of the subject utilizing a print head 1130 that is configured to deposit layers of materials according to the high resolution image.

Alternatively, the user could place the subject (e.g., the artichoke in the example of FIG. 1) in the 3-D printing device 1002(2). The 3-D printing device could use its depth camera 104 to capture a set of low resolution depth images. The 3-D printing device's depth dependent measurement modeling component 116 can use the depth dependent pixel averaging function for its depth camera 104 that is stored on the device's storage 1022 to generate the high resolution image of the subject. Examples of specific techniques, functions, and examples of equations are provided in the discussion above relative to FIG. 8. The print head 1130 could then generate the replica of the subject from the high resolution image.

In other cases, an individual device 102, 1002(1), 1002(2), and/or 1002(3) could have a less robust depth dependent measurement modeling component 116. In such a case, the device could send the set of low resolution images (unprocessed or partially processed) to cloud based depth dependent measurement modeling component 116(3) which could generate the corresponding high resolution image utilizing a depth dependent pixel averaging function 118(3) for the individual device. For instance, the individual device could send the depth dependent pixel averaging function with the low resolution images as metadata. Alternatively, the cloud based depth dependent measurement modeling component 116(3) could maintain and/or access a table that includes the depth dependent pixel averaging functions for various models of depth cameras. The cloud based depth dependent measurement modeling component 116(3) could use the corresponding depth dependent pixel averaging function for the model of depth camera in the individual device to generate the high resolution image. The cloud based depth dependent measurement modeling component 116(3) could then return the high resolution image to the individual device, store the high resolution image in the cloud, and/or take other actions, such as sending the high resolution image to the 3-D printing device 1002(2).

From one perspective, any of devices 102, 1002(1), 1002(2), and/or 1002(3) can be thought of as computers. The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the computer. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and/or flash memory, among others.

As mentioned above, configuration 1008(2) can be thought of as a system on a chip (SOC) type design. In such a case, functionality provided by the device can be integrated on a single SOC or multiple coupled SOCs. One or more processors can be configured to coordinate with shared resources 1016, such as memory, storage, etc., and/or one or more dedicated resources 1018, such as hardware blocks configured to perform certain specific functionality. Thus, the term “processor” as used herein can also refer to central processing units (CPUs), graphical processing units (CPUs), controllers, microcontrollers, processor cores, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

In some configurations, the depth dependent measurement modeling component 116 and/or the device model specific depth dependent pixel averaging function 118 can be installed as hardware, firmware, or software during manufacture of the computer or by an intermediary that prepares the computer for sale to the end user. In other instances, the end user may install the depth dependent measurement modeling component 116 and/or the device model specific depth dependent pixel averaging function 118, such as in the form of a downloadable application and associated data (e.g. function).

Examples of computing devices can include traditional computing devices, such as personal computers, desktop computers, notebook type computers, cell phones, smart phones, personal digital assistants, pad type computers, entertainment consoles, 3-D printers, and/or any of a myriad of ever-evolving or yet to be developed types of computing devices. Further, aspects of system 1000 can be manifest on a single computing device or distributed over multiple computing devices.

### First Method Example

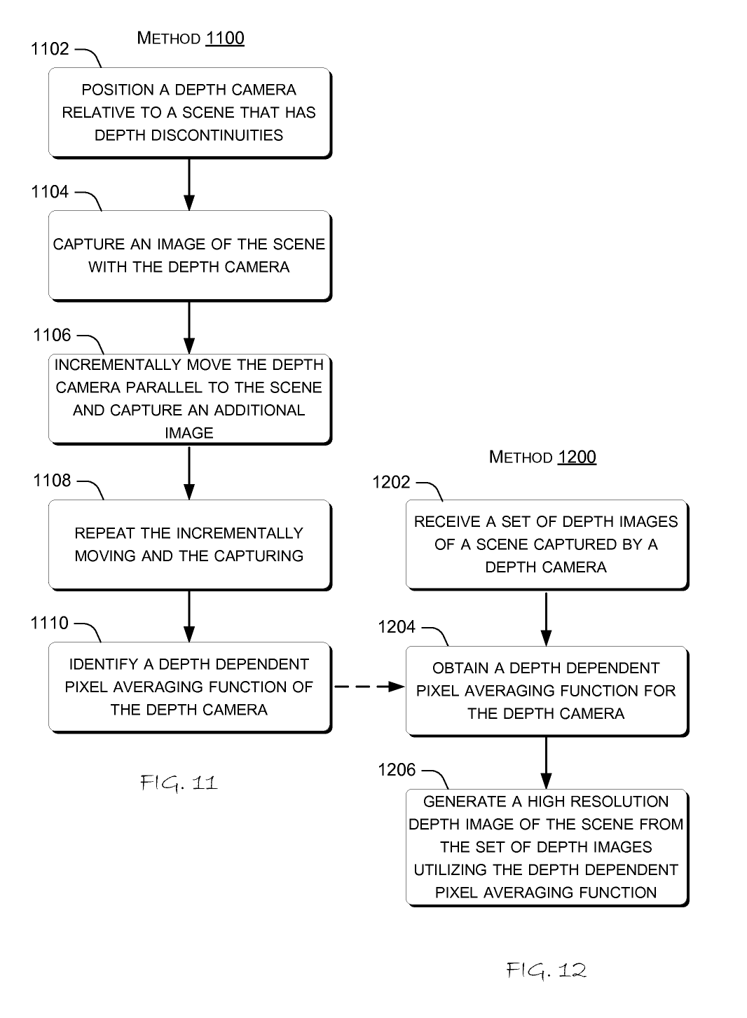

FIG. 11 shows an example depth image resolution enhancement method 1100.

In this case, at block 1102 the method can position a depth camera relative to a scene that has depth discontinuities. The depth camera can include sensors that capture pixels of the scene.

At block 1104 the method can capture an image of the scene with the depth camera.

At block 1106 the method can incrementally move the depth camera parallel to the scene a sub-pixel distance and capture an additional image.

At block 1108 the method can repeat the incrementally moving and the capturing an additional image to capture further images so that the depth camera captures the depth discontinuities.

At block 1110 the method can identify a depth dependent pixel averaging function of the depth camera from the image, the additional image, and the further images. Thus, method 1100 can identify the depth dependent pixel averaging function for an individual depth camera. In method 1100, the depth dependent pixel averaging function can be utilized to enhance depth images from that depth camera or for similar depth cameras (e.g. depth cameras of the same model).

### Second Method Example

FIG. 12 shows an example depth image resolution enhancement method 1200.

In this case, at block 1202 the method can receive a set of depth images of a scene captured by a depth camera.

At block 1204 the method can obtain a depth dependent pixel averaging function for the depth camera. For instance, the depth dependent pixel averaging function for the camera could be identified utilizing method 1100 for the depth camera or a similar depth camera.

At block 1206 the method can generate a high resolution depth image of the scene from the set of depth images utilizing the depth dependent pixel averaging function.

The methods described above can be performed by the systems and/or devices described above relative to FIGS. 1-10 and/or by other devices and/or systems. The order in which the methods are described is not intended to be construed as a limitation, and any number of the described acts can be combined in any order to implement the method, or an alternate method. Furthermore, the method can be implemented in any suitable hardware, software, firmware, or combination thereof, such that a device can implement the method. In one case, the method is stored on computer-readable storage media as a set of instructions such that execution by a computing device causes the computing device to perform the method.

### CONCLUSION

Although techniques, methods, devices, systems, etc., pertaining to depth image resolution enhancement are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A computer implemented method, comprising:
positioning a depth camera relative to a scene that has depth discontinuities; the depth camera comprising sensors that capture pixels of the scene;
capturing an image of the scene with the depth camera;
incrementally moving the depth camera parallel to the scene a sub-pixel distance and capturing an additional image;
repeating the incrementally moving and the capturing an additional image to capture further images so that the depth camera captures the depth discontinuities; and,
identifying a depth dependent pixel averaging function of the depth camera from the image, the additional image, and the further images.

2. The method of claim 1, wherein the depth camera is a red, green, blue+depth (RGBD) camera.

3. The method of claim 1, wherein the incrementally moving comprises moving the depth camera or moving the scene.

4. The method of claim 1, wherein the method is performed by a manufacturer of the depth camera or a manufacturer of a device that incorporates the depth camera as a component.

5. The method of claim 1, further comprising storing the depth dependent pixel averaging function on the depth camera or on other depth cameras that are a same model as the depth camera.

6. At least one computer-readable storage medium having instructions stored thereon that when executed by a computing device cause the computing device to perform acts, comprising:
receiving a set of depth images of a scene captured by a depth camera;
obtaining a depth dependent pixel averaging function for the depth camera; and,
generating a high resolution depth image of the scene from the set of depth images utilizing the depth dependent pixel averaging function.

7. The computer-readable storage medium of claim 6, wherein the receiving comprises capturing the set of depth images, or wherein the receiving comprises receiving the set of depth images from a device that captured the set of depth images.

8. The computer-readable storage medium of claim 6, wherein the obtaining the depth dependent pixel averaging function for the depth camera comprises identifying the depth dependent pixel averaging function by incrementally moving the depth camera relative to a subject and capturing additional images and calculating the depth dependent pixel averaging function from the additional images.

9. The computer-readable storage medium of claim 6, wherein the obtaining the depth dependent pixel averaging function for the depth camera comprises obtaining the depth dependent pixel averaging function with the set of depth images.

10. The computer-readable storage medium of claim 6, wherein the obtaining the depth dependent pixel averaging function for the depth camera comprises obtaining the depth dependent pixel averaging function for a model of the depth camera.

11. The computer-readable storage medium of claim 6, wherein the generating the high resolution depth image comprises generating the high resolution depth image utilizing the depth dependent pixel averaging function and depth dependent noise characteristics for the depth camera.

12. The computer-readable storage medium of claim 6, further comprising storing the high resolution depth image, or returning the high resolution depth image to a device from which the set of depth images was received.

13. A device, comprising:
a depth camera;
storage configured to store computer-executable instructions;
a processor configured to execute the computer-executable instructions;
a depth dependent pixel averaging function of the depth camera stored on the storage; and,
a depth dependent measurement modeling component configured to apply the stored depth dependent pixel averaging function to a set of depth images of a subject captured by the depth camera to produce a relatively higher resolution depth image of the subject.

14. The device of claim 13, wherein the depth camera comprises a red green blue+depth (RGBD) camera.

15. The device of claim 14, further comprising a display and wherein the depth dependent measurement modeling component is configured to present the relatively higher resolution depth image on the display as a RGBD image.

16. The device of claim 13, wherein the depth camera is a time of flight depth camera, or wherein the depth camera is a structured light depth camera or wherein the depth camera is a stereo depth camera.

17. The device of claim 13, wherein the device is manifest as a smart phone, a pad type computer, a notebook type computer, or an entertainment console.

18. The device of claim 13, wherein the device is manifest as a 3-D printer and also includes a print head configured to deposit material based upon the high resolution image to create a replica of the subject.

19. The device of claim 13, wherein a 3-D resolution of the relatively higher resolution depth image is at least about two times the 3-D resolution of any individual depth image of the set of depth images.

20. The device of claim 13, wherein a 3-D resolution of the relatively higher resolution depth image is at least about three times the 3-D resolution of any individual depth image of the set of depth images.
